(19) United States
(12) Patent Application Publication
(10) Pub. No.: US 2007/0099168 A1
(43) Pub. Date: May 3, 2007

(54) Method of configuring and evaluating a document

(76) Inventor: Jeffrey A. Nielsen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,197

(22) Filed: Oct. 28, 2005

(51) Int. Cl. G09B 7/00; G09B 3/00

(52) U.S. Cl. 434/353; 434/362

(57) ABSTRACT

A method for configuring and evaluating documents is described. A printing device accesses data that describes a document which includes one or more user designation areas. The printing device prints a first version of a document with user designation areas. The user completes the user designation areas and the printing device determines which user designation areas have been completed. The printing device accesses data from the computer where printed information is generated based on the completed users designated areas.

### BACKGROUND

There is an ongoing need for people to select from a variety of choices in their daily life. Although most choices are verbal, instinctive, or even automatic; some of the most notable and important choices require careful thought and deliberation. Examples of the latter include; filling out surveys, taking assessment or placement tests, voting for candidates, updating medical records etc. Most experts agree that in the future, computers will become so ubiquitous that essentially everyone will have direct access to a computer when making choices, although to date; this has not happened, and peoples experiences when making choices has been mixed. For example, using computers for interactive driver's license testing has enjoyed a long period of success, and recently adaptive computerized graduate school testing has shown promise. However, in many other applications, there has been a lack of acceptance for people to directly interface with computers due to concerns about cost, security, and possibly general unfamiliarity with computer technology. For instance, neither directly casting votes, nor routine testing in academic settings are directly performed by computers, rather, in both of these situations, choices are performed by filling in bubbles on ballots and answer sheets.

There are at least three major problems with standard methods for filling in bubbles on ballots or answer sheets. First, the lack of randomization, or the strict ordering, in which choices are presented. Second, the unnaturalness of testing when questions are presented in one format and answers are required in another format. Finally, the disassociation of test answers with test questions in a learning environment.

In the first case, strict ordering makes a difference in the outcome of balloting and testing. For instance, when voting, the order in which the candidates are presented tends to bias voter preference, the preference being given to a first candidate. In other words, assuming there are two candidates are on a ballot and all other factors are roughly equal, the first candidate on the ballot generally receives a greater number of votes than the second candidate. This problem of non-randomization or strict ordering also applies to testing, where test questions that are arranged in a predictable fashion make it easier to copy answers from another persons test.

Secondly, the great majority of standardized tests require users to read questions in one format and answer these questions by filling in bubbles in another format, for example on a bubble sheet. Since the test questions and the answer sheet are independent from each other, it is necessary for the test taker to read and formulate answers to the questions and then go to the answer sheet exercising care when filling in the corresponding bubble to the question. This testing method is both unnatural and may lead to significant testing errors, especially in the situation where a student is off by a question or a bubble.

A third problem also occurs when testing questions are in one format and the answer sheet is in another format. When the answer sheet is graded, a report typically consists of scores, raw numbers, or a variety of sometimes misleading statistics based on question types. The causal linkage between actual questions asked and the answers recorded is greatly reduced because the question sheet and answer sheet are separated, thereby leading to reduced insight and learning.

Because there are significant numbers of applications where people do not or will not directly interface with computers; and since it may be many years or even decades before all of society is able to directly interface with computers to make important choices; it appears for at least the next few years, answer sheets in the form of bubble sheets will continue to become commonplace. Therefore, there is a need to develop an enhanced or alternate method to improve the accuracy and efficacy of balloting, standardized test taking, marketing surveys, order entry, health data entry, laboratory testing, prescription processing and in other situations where information is gathered or choices are made using bubble sheets.

### BRIEF DESCRIPTION OF THE DRAWINGS

FIG. 1 is a system architecture diagram for a document configuration and evaluation system according to one embodiment of the invention.

FIG. 2 illustrates an example of a first version of a printed document from a printing device according to one embodiment of the invention.

FIG. 3 illustrates an example of the first version of the printed document with a completed user designation area being determined by a printing device according to one embodiment of the invention.

FIG. 4 shows a second version of the printed document with printable information from the completed user designation area that have been determined by a printing device according to one embodiment of the invention.

FIG. 5 shows another example of a first version of a printed document before a user has completed the user designation areas according to one embodiment of the invention.

FIG. 6 shows a process flow chart that provides an example of the document configuration and evaluation system according to one embodiment of the invention.

### DETAILED DESCRIPTION OF THE EMBODIMENTS

The embodiments of the invention are directed to a system which configures and prints a first version of a document, accepts answers filled in by a user on the first version of a printed document, evaluates the answers on the first version of a printed document, and prints additional information on the first version of a printed document thereby creating a second version of a printed document.

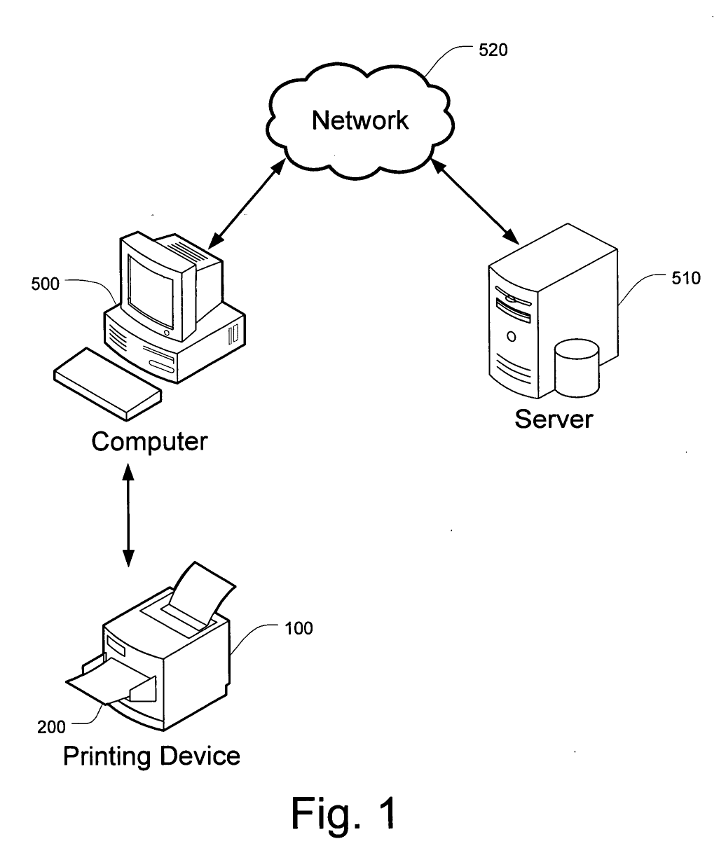

FIG. 1 shows a system architecture diagram for a document configuring and evaluation system according to one embodiment of the invention. Printing device 100 is connected to computer 500, and although the connection has been shown to be direct between printing device 100 and computer 500, the connection can also be established indirectly through routing networks etc. Printing device 100 may include an inkjet printer, a laser printer, an electrophotographic printer, a thermal printer, an impact printer, a transfer based printer, an all-in-one printer, or any other type of printer capable of printing information on paper. Printing device 100 and computer 500 communicate together for the purpose of printing documents where data for the documents generally resides on computer 500. Computer 500 may output data for document generation to printing device 100. Printing device 100 may access data from computer 500 or the internal memory of printing device 100, etc.

It is not necessary for data to reside on computer 500. Data may reside on server 510 where printing device 100 may access data from server 510 through network 520 and computer 500. Network 520 may be an internet or intranet connection, a wired or wireless connection, and may include routers, switches, hubs, or other network communication devices.

Although in FIG. 1 printing device 100 has been shown to be connected directly to computer 500, printing device 100 may also be connected to a printer network where multiple printing devices 100 are connected to a single computer 500. Alternately, multiple computers 500 may be connected to a single printing device 100 using a printer network, print spooler, or similar device. Likewise, multiple printing devices 100 may be connected to multiple computers 500 or other printing devices 100. Also, printing device 100 may access data directly through a network connection to one or more servers 510. This network connection and the previously mentioned options are not shown for the purpose of clarity, however, these options can be used allowing broader distribution and sharing of data between computers 500, printing devices 100, and servers 510. It will be appreciated that the embodiment of the invention as shown in FIG. 1 is not limited to a single printing device 100, single computer 500, single server 510, or single network 520, but rather multiple printing devices, computers, servers, and networks can be used along with network devices such as hubs, switches, routers, etc.

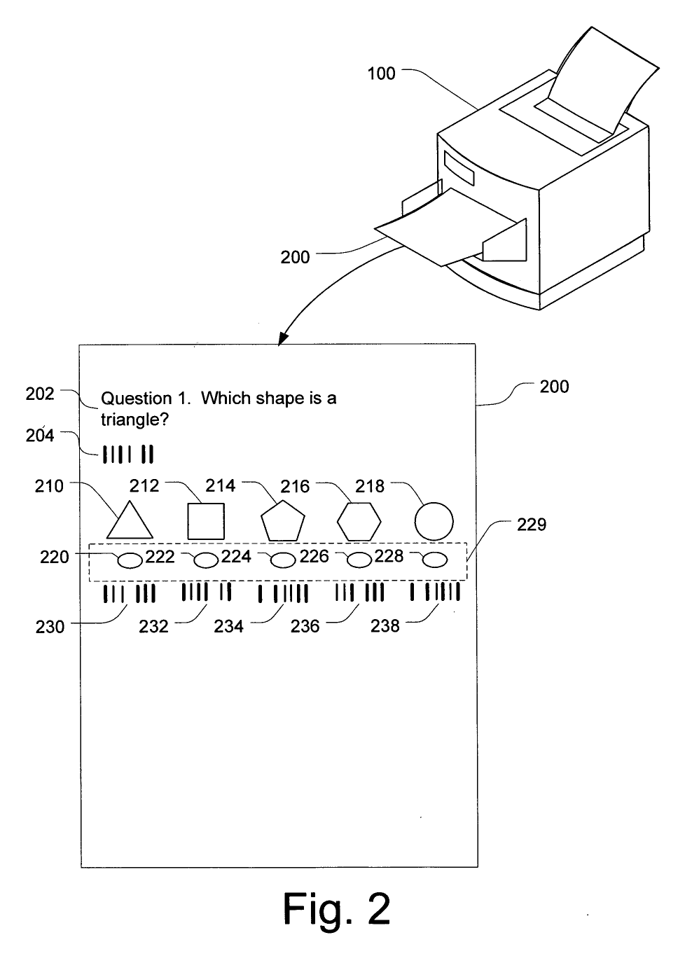

As an example of a printing application, data resides on a computer 500 or a server 510 and when desired, document 200 is printed on printing device 100. Document 200 can take the form of many documents for the purpose of voting, health questionnaires, test taking, marketing, order entry, health data entry, laboratory testing, prescription processing etc. Document 200 is not limited to, but for example, takes the form of an educational test question shown in FIG. 2 to illustrate one embodiment of this invention.

FIG. 2 shows an example of a first version of a printed document 200 from a printing device 100 according to one embodiment of the invention. As in reference to FIG. 1, data that describes a document may be stored in many places. For example, the data may be stored in computer 500, server 510, internal memory of printing device 100, etc. as shown in FIG. 1. This data is called first data and describes an initial document. The first data is configured by the computer 500 in FIG. 1 and printed by printing device 100 to yield a first version of a printed document 200 in FIG. 2. An optical mark reader is included on Hewlett-Packard DeskJet™, PhotoSmart™, and OfficeJet™ printers. The optical mark reader is a light emitting diode including a phototransistor and is used for paper alignment and media (paper) sensing found on contemporary Hewlett-Packard printers. The optical mark reader is typically used to monitor the print quality of the first version of document 200 to determine, for instance, whether the printing device 100 is low on ink, nozzle print quality, print cartridge to paper alignment etc. The optical mark reader for the inkjet printing devices 100 mentioned above is coupled to a print cartridge carriage and moves with a print head on the print cartridge. Although the primary purpose of the optical mark reader is to monitor print quality, this optical mark reader can also be used to read user marks on printed documents in user designated areas. Use of the optical mark reader to read these user marks on printed documents will be described later on.

Document 200 is just one example of what can be printed and therefore does not limit the invention, since there are many other examples of printed documents which could also exemplify an embodiment of the invention.

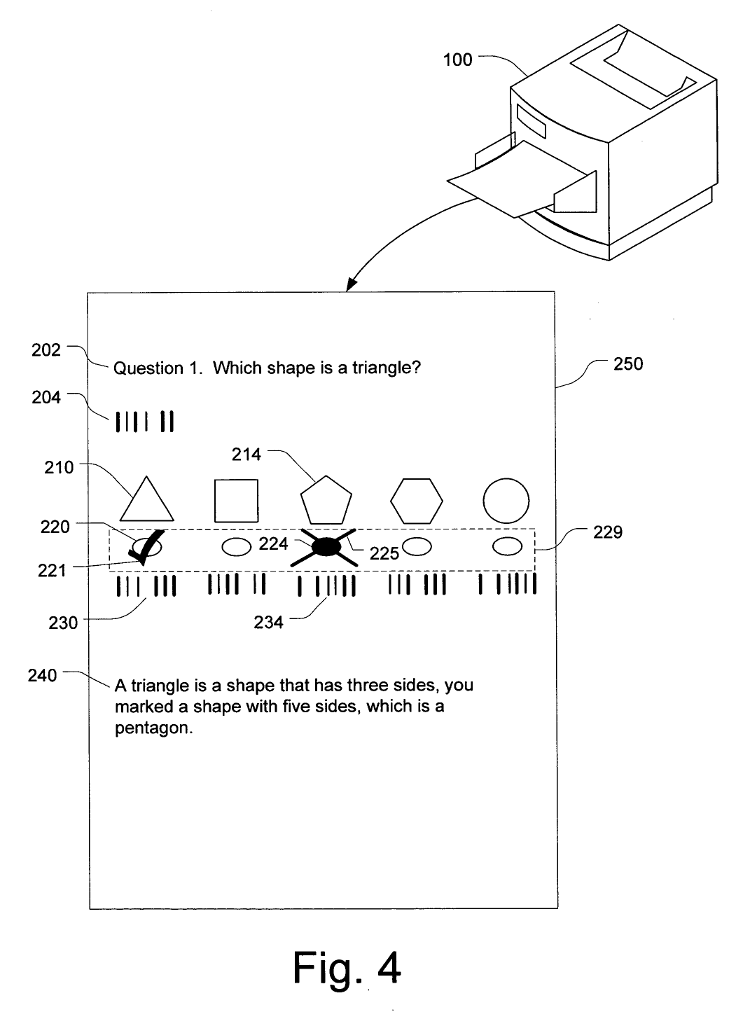

Document 200 includes question 1 (202) which is printed in human readable text. Question 1 (202) asks the reader about the shape of a triangle. In general, there may be more human readable text to help establish context for question 1 (202), however for clarity of FIG. 2, this human readable text is not shown. A unique machine readable mark 204 is printed near question 1 (202) and allows a machine, such as a computer 500, shown in FIG. 1 to uniquely identify question 1 (202) by associating the code word of machine readable mark 204 to question 1 (202) in computer 500 shown in FIG. 1. Similarly, machine readable marks 230, 232, 234, 236, and 238 are used to identify answer choices. In this example, machine readable marks 204, 230, 232, 234, 236 and 238 are shown as barcodes, but in general, checkerboard codes, or other machine readable marks could be used and thus machine readable marks 204, 230, 232, 234, 236, and 238 are not limited to barcodes. The process of configuring and evaluating a document is briefly described below, however, the configuring and evaluating process will be described in detail in reference to FIG. 4.

In FIG. 2, triangular shape 210 is human readable and represents one answer to question 1 (202). Bubble 220 is a user designated choice corresponding to triangular shape 210. If the user thinks that triangular shape 210 is the correct answer to question 1 (202), the user can fill in bubble 220 by marking on document 200 with a pen, pencil, or other device to designate the choice of a triangular shape 210. Bubble 220 is in a user designation area 229 shown by a dashed box, however the user designation area 229 box is not printed on document 200, rather it is shown to aid in the description of an embodiment of the invention. Machine readable mark 230 serves to uniquely identify the answer to a question since bubble 220, triangular shape 210, and machine readable mark 230 are all associated with each other. In a similar manner, other geometric shapes 212, 214, 216, and 218 and bubbles 222, 224, 226, and 228 are matched correspondingly to machine readable marks 232, 234, 236, and 238.

After first version of printed document 200 has been printed, it is ready for a user to complete. The user takes first version of printed document 200 and completes question 1 (202) by filling in a bubble within the user designation area 229 closest to a geometric shape corresponding to the users answer. Candidate bubbles for answer choices corresponding to triangle, square, pentagon, hexagon, and circle are bubbles 220, 222, 224, 226, and 228 respectively.

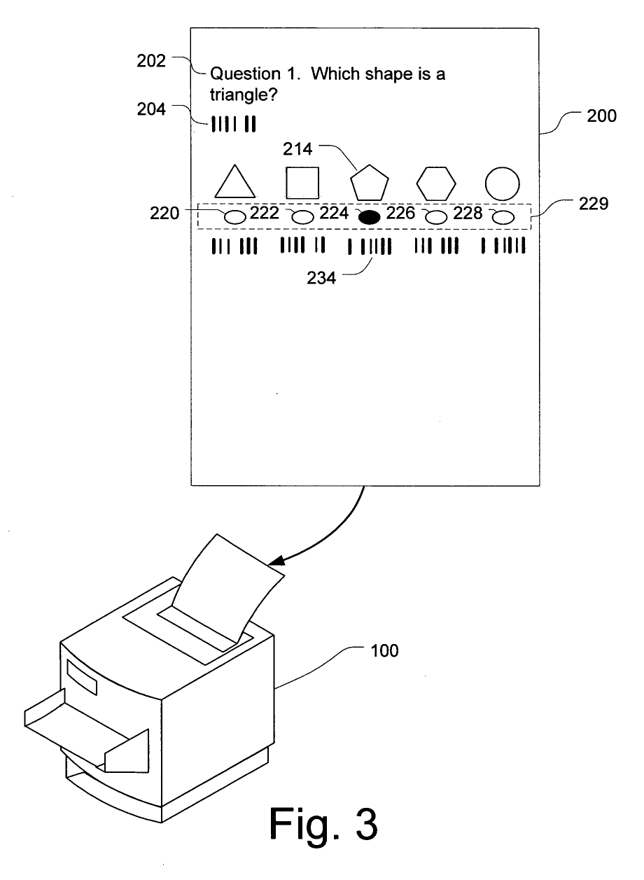

FIG. 3 illustrates an example of the first version of printed document 200 having a completed user designation area 229. In this case, bubble 224 within the user designation area 229 just below the geometric shape of a pentagon 214 has been filled-in to signify that the users' answer choice for question 1 (202) is a pentagon 214. Machine readable mark 234 is associated with bubble choice 224 and pentagon 214.

After first version of printed document 200 is completed by filling in the appropriate bubble in user designation area 229, first version of printed document 200 is fed back into the printing device 100. As previously mentioned, an optical mark reader (not shown) is used to determine print quality, but in the embodiment of the invention, the optical mark reader can also be used to read, for example, machine readable mark 204 (to identify the code word for question 1 (202)), user completed bubble 224 (to identify users answer of a pentagon 214) in user designation area 229, and machine readable mark 234 (to identify the code word for answer 214) as shown in FIG. 3. In other words, the optical mark reader detects the filled in bubble 224 in user designation area 229 as the users answer choice to question 1 (202) which is a pentagon 214. In this example, an optical mark reader is used to detect the bubble 224 filled-in by the user in the user designation area 229. An optical mark reader is coupled to the inkjet print cartridge carrier in Hewlett-Packard Desk Jet™, PhotoSmart™, and OfficeJet™ inkjet printers and serves to enable this task. It is not necessary that the printing device 100 use an optical mark reader, since other methods for reading machine readable marks 204 and 234, and filled in bubble 224, can be used. These alternate methods may take the form of a flat bed scanner, an all-in-one (printer, scanner, facsimile, and copier), a barcode reader, etc.

In the case where the optical mark reader, the flat bed scanner, a barcode reader, etc. cannot, or has difficulty reading marks in the user designation area, the completed first versions of printed documents 200 which cannot be read or have difficulty being read can be sent to an alternate paper output tray such as a second paper output tray in a printing device 100. The second paper output tray is often called a duplex tray. The documents in the second or duplex tray can conveniently be examined for marking errors, feed errors, or similar types of problems.

Both the code for the machine readable mark 204 (corresponding to question 1 (202)) and the code for the machine readable mark 234 (the answer choice of pentagon 214 via filled in bubble 224), are output to a computer or server as shown in FIG. 1. The computer or server evaluates the two codes, one associated with question 1 (202) and one associated with answer choice of pentagon 214 and determines whether the answer is correct. Data is sent back to the printing device 100. This data is termed second data and the type of data sent depends on whether the answer choice is correct or not. In this example, the answer of a pentagon 214 in response to question 1 (202) regarding the shape of a triangle is incorrect, and the second data sent to the printing device 100 includes information printed on document 200 in response to the incorrect answer choice as shown in FIG. 4. As another example, if the user had instead chosen the correct answer, triangle 210, the second data sent to the printing device might include a comment stating: “Your answer is correct, the triangle shown is an equilateral triangle. What other types of triangles are there?”

After first version of printed document 200 having completed user designation area 229 is still in the printing device 100, second printable information is printed on first version of printed document 200 from second data to create a second version of printed document 250 shown in FIG. 4 according to an embodiment of the invention. Although it is preferable to keep document 200 in the printing device, document 200 can be removed from the printing device for the purpose of reading it by another print device. Even if printing device 100 does not have an optical mark reader, this function can be enabled by the scanning portion of an all-in-one (printer, scanner, facsimile, and copier) which may be used to read the optical marks.

Document 250 is called a second version of printed document 250 because a second set of data is printed on first version of printed document 200 as the first version of printed document 200 passes through printing device 100 a second time. Returning to the example shown in FIG. 3, since the user marked bubble 224 in the user designation area 229 as the chosen answer to question 1 (202), the computer 500 or server 510 in FIG. 1 evaluates both the code of machine readable mark 204 associated with question 1 (202) and the code of machine readable mark 234 associated with answer choice of pentagon 214 and determines whether the answer choice is correct. In this case the answer choice is incorrect, and the printing device 100 accepts information from the computer 500 or server 510 in FIG. 1, and prints an X mark 225, a check mark 220 (associated with the correct answer which is a triangle 210), and a textual explanation 240 as to why the answer chosen is incorrect on first version of printed document 200 thereby yielding a second version of printed document 250 in FIG. 4. The optical mark reader can be used to verify that the second set of data has been printed on second version of printed document 200 and that, for example, the printing device is not out of ink, toner, or other marking material. Also, rather than using a check mark 220 or an X mark 225, other types of marks can be used and printed in a variety of colors.

In a typical situation, more than one question 202 will be on a document. In this case, the bubbled answers, for example 224, to the question 202 can be read by the optical mark reader. Directly after reading the bubbled answer choice 224, the printing device 100 can mark the correct answer 220, the incorrect answer 225 and user comments 240 as shown in document 250 in FIG. 4. All this processing happens before the printing device goes on to read the next question. Operation in this manner exercises an inkjet print cartridge more frequently and helps to prevent the nozzles in an inkjet cartridge from clogging rather than reading all the questions on the document one after the other and then returning to the questions to print the answers and users comments.

In some situations, it is desirable to have an electronic copy of the second version of the printed document 250. This second version of the printed document 250 may be stored in a database where the electronically stored second version of a printed document 250 may be a replacement for the second version of printed document or it may augment the second version of printed document 250. The electronically stored version of the printed document 250 may be archived, printed at a later date, reviewed locally, reviewed remotely, evaluated remotely in comparison with other documents by educators, students, health care personnel, government officials, marketing and sales people, etc. depending upon the application of the embodiment of the invention.

It should be appreciated that in an embodiment of the invention, as a first version of document 200 passes through printing device 100 a second time to create a second version of document 250, second version of document 250 becomes a self contained record of question 1 (202), candidate answer choices 210, 212, 214, 216, and 218; user designation area 229, including bubbles 220, 222, 224, 226, and 228; and textual explanation 240, which serves as direct feedback to a test taker, teacher etc. The embodiment of the invention thereby provides a direct one-to-one correspondence between, for example, question 1 (202) and answer choice 224, even though in error, thereby promoting and facilitating learning. This method of learning is much better than existing methods where answer choices are on, for example, a bubble sheet and the test taker is given an answer key, summary report, etc. requiring the test taker to tediously cross reference answers to question books which may not be readily available and with no user feedback.

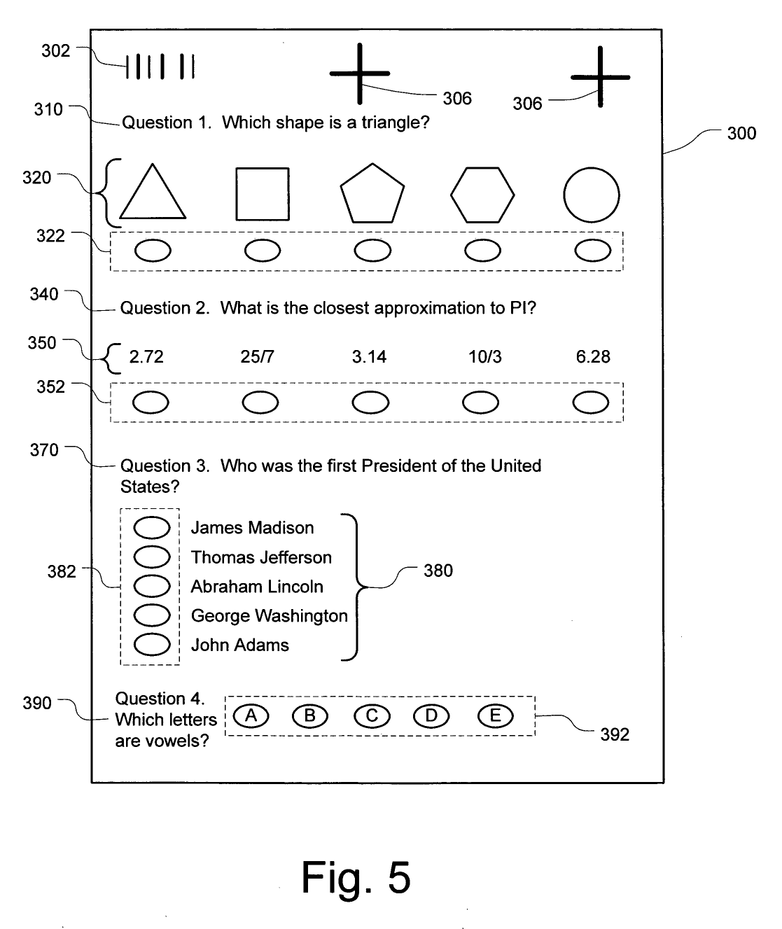

Embodiments of the invention have been described in reference to FIGS. 1 through 4, however, there are variations to a first version of printed document 200 that may be useful for some types of testing and are shown in FIG. 5. FIG. 5 shows another example of a first version of a printed document 300 before a user has completed the user designation areas according to one embodiment of the invention. First version of printed document 300 is somewhat different than first version of printed documents 200 shown in FIGS. 2 and 3 in that it has one machine readable mark 302 which can function as a unique test identifier. First version of printed document 300 includes questions 310, 340, 370, and 390, user designation areas 322, 352, 382, and 392. Human readable answer choices 320, 350, 380, and 390 are placed proximate to user designation areas 322, 352, 382, and 392. Markings in the user designation area closest to the answer choices select the answer choice. The dashed boxes around user designated areas 322, 352, 382, and 392 are not printed on first version of printed document 300, but rather are used to help illustrate and describe FIG. 5. After first version of printed document 300 is printed, the user fills in user designation areas closest the answer choices. Question 1 (310) is the same as question 1 (202) in FIG. 2. To obtain a correct answer choice, the user fills in the bubble in the user designation area 322 directly below and corresponding to the shape of a triangle. In question 2 (340) the format of the question is similar to question 1 (202) in FIG. 2, and to obtain the correct answer choice, the user fills in the bubble in the user designation area 352 directly below and corresponding to the closest approximation to PI. In question 3 (370), the format of the question is changed somewhat, in that the user fills in the user designation area 382 that is to the left of answer choices 380. In question 4 (390), the format of the question is changed again in that the answer choices are embedded in the user designation area 392. Notice that one machine readable mark 302 is printed on document 300 rather than the many machine readable marks 204, 230, 232, 234, 236, and 238 as shown in FIG. 2.

Rather than evaluating a machine readable mark code for each question and each answer as shown in FIG. 2, the evaluation system keeps track of answers by associating a first version of document 300 with a machine readable mark, for example the machine readable mark 302 in FIG. 5. An electronic version of a first version of a printed document 300 can be saved to a server, computer, or other processing device, and upon user completion of filling in the user designation areas 322, 352, 382, and 392, thereby creating a second version of printed document 300, these user designated choices can be evaluated by the saved electronic version of the document 300.

Alignment of a second version of printed document 300 to printer 100 can be performed by aligning the optical mark reader to a machine readable mark 302 or by aligning the second version of printed document 300 to one or more alignment target marks such as 306.

Although several types of question formats have been shown in FIG. 5, these examples have been cited to help illustrate embodiments of the invention, and thus the embodiments of the invention are not limited to the formats described by these examples. Other formats and printed user feedback which include photographs, colors, references to other information in the form of hyperlinks, citations etc. may also be used without departing from the intent of the embodiment of the invention. An identification number, name, alias, or other unique identifier may also be included in a user designation area to be filled in by the user, and may be used for tracking data and results.

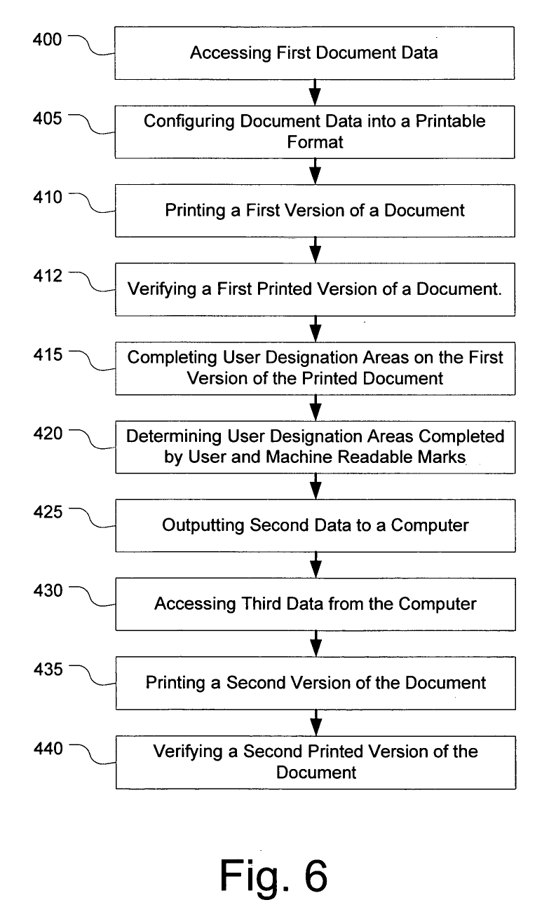

FIG. 6 is an example of a process flow chart providing the steps for a document configuration and evaluation system according to one embodiment of the invention. In step 400, the first document data is accessed. The data may be in the form of a database on a server, a local computer, local processor, processor in a printing device etc. The data may include a variety of test questions, ballot information for different regional areas, marketing surveys, order information, health information, laboratory testing information, prescription processing information, survey questions, health related questionnaires, etc.

In step 405 document data configured. After the first data has been accessed, the data is configured into a printable document with user designation areas. The data may be configured into a printable document that may consist of randomized questions from a database for the purpose of reducing bias in balloting, reducing the likelihood of copying, grouping questions by level of proficiency etc.

In step 410 a first version of a document is printed. After the first data has been accessed and configured, the first data is used to print a first version of document 200 shown in FIG. 2. For example, document 200 may include one or more questions 202; one or more answer choices 210, 212, 214, 216 or 218; one or more user designation areas 229 including bubbles 220, 222, 224, 226, or 228 which are proximate to answer choices 210, 212, 214 216, or 218 respectively; one or more machine readable marks 204 associated with question 1 (202); or one or more machine readable marks 230, 232, 234, 236, or 238. The machine readable marks 230, 232, 234, 236, and 238 correspond to bubbles 220, 222, 224, 226, and 238, and human readable answer choices 210, 212, 214, 216, and 218 respectively.

In step 412, an optical mark reader may be used to verify that the first version of document 200 has been properly printed. The optical mark reader may verify that the printing device 100 is not out of ink, low on printing supplies, etc. by detecting printed information on document 200.

In step 415, a user completes user designation areas on first version of printed document. A user completes bubbles 220, 222, 224, 226, or 228 in one or more user designation areas 229 on a first version of document 200 shown in FIG. 3. For example, the user has completed bubble 224 in user designation area 229.

In step 420, one or more user designation areas are determined and one or more machine readable marks are read. Printing device 100 determines bubble 224 in user designation area 229 corresponding to answer choice 214, a pentagon, and reads the unique code of machine readable mark 234 associated with the answer choice of a pentagon 214. Printing device 100 also determines the unique code associated with machine readable mark 204 indicating the question. The chosen answer of pentagon 214 by marking of bubble 224 in the user designation area 229, and the machine readable marks 204 and 234 may also be read by an optical mark reader, barcode reader, or other device such as the scanner in an all-in-one (printer, scanner, fax, copier).

In step 425 the printing device 100 outputs second data to a computer, processor, or other type of computing device. The printing device 100 outputs second data to a computer including the code for the machine readable mark 234 which corresponds to users answer choice 214 by marked bubble 224 in user designation area 229. The printing device 100 also outputs second data including the code for a machine readable mark 204 which corresponds to question 1 (202). These two codes are accepted by a computer 500, server 510, or another processing device or devices including one or more computers or servers and evaluated as shown in FIG. 1.

In step 430 the printing device 100 accesses third data from a computer, processor or computing device. The printing device 100 accesses third data from computer which is the result of evaluation of the codes from machine readable marks 204 (the question) and 234 (the answer) from computer 500, server 510, or other processing device as shown in FIG. 1. The third data includes information to be printed on first version of document 200 by evaluating the answer choice to the question.

In step 435, information is printed on first version of printed document to create a second version of printed document. Information in step 430 is printed on first version of printed document 200 as shown in FIG. 4. Once this information is printed on first version of printed document 200, first version of printed document 200 is termed a second version of printed document 250. For instance, in FIG. 4, second version of printed document 250 includes the correct answer choice identified with a check mark 221, the incorrect answer choice identified with an X mark 225, and a textual explanation 240 as feedback to the user.

In step 440, verification of a second printed document is performed. An optical mark reader may be used to verify that the second version of document 250 has been properly printed. The optical mark reader verifies that the printing device 100 is not out of ink, low on printing supplies, etc. by detecting printed information 10 on second version of printed document 250 such as check mark 221, X mark 225, or textual explanation 240 in FIG. 4.

As described previously, steps 420, 425, 430, 435, and 440 may be done one question at a time for-the purpose of reducing the clogging of inkjet nozzles and preserving nozzle health. After steps 420, 425, 430, and 440 are performed on one question, they are performed on the next question, etc. until no more questions remain.

The embodiments described in the invention allow users to access and make use of a low cost, highly personal interactive testing system. This opportunity is afforded to many users because a low cost printing device 100 has been coupled with an optical mark reader enabling plain paper to be used rather than expensive specialized equipment, forms, and supplies. By integrating the printing devices' 100 printing function with the reading function, users are provided with a system capable of customizing content, randomizing questions, directly linking questions to answers, providing feedback on documents to users and other useful features. Along with the embodiments in the invention, all of these capabilities are possible using DeskJet™, Photosmart™, and OfficeJet™ inkjet printers by Hewlett-Packard, since these printers have optical mark readers built into the printer coupled to the inkjet cartridge assembly for the purpose of monitoring print quality. Prior to the embodiments described in the invention, limitations associated with testing and many other application could not provide for the questions and answers to be placed on the same bubble form document, would not allow the use of pictures or graphics on bubble form documents, and did not enable an effective way of configuring and analyzing mass randomization of questions and answers on bubble form documents. Using the embodiments described and illustrated in the invention, these limitations have been eliminated and therefore a much richer, intuitive, interactive, and cost effective system has been developed using bubble form documents. It is appreciated that bubble form documents have been used to illustrate and explain embodiments of the invention, however it should be understood that a wide variety of user marking techniques could be used without deviating from the intent of the invention. For example, check marks in boxes, circles around correct answers, punched through areas within a user designated area etc. may be used.

The use of the integrated optical mark reader in a printing device for configuring and evaluating documents where the marks are made in user designated areas can also be used in a wide variety of applications such as but not limited to: Voting, where regional candidates may be printed on a ballot in randomized order to remove candidate bias and then read by the same printing device upon completion of voting and results uploaded to a database. Printing customized marketing questionnaires and reading them on the same printing device that printed the questionnaires, where the data may be sent to a database. Order entry, where choices are marked on a printed form and then read in by a printer to place an order. Health questionnaires to assess the currency of patient health before administering treatment and recording information to a database. Age, gender, and other specific questions about health history may be answered on a document and information may be sent to a database to update a patients' health record. Lab information where analytical tests are specified on a printed form and after analytical tests have been performed, test results are read from the completed form by a printing device and data may be uploaded to a database. Prescription processing, where health care providers may prescribe a drug or treatment by completing a form, where the pharmacy or therapy office reads the prescribed treatment using a printing device with a optical mark reader and may upload this information to a database. Finally, there are many other applications where choices are made everyday that are enabled through the use of one or more optical mark readers in a printing device using a computing unit described in an embodiment of the invention, and it should be understood that the examples cited above are not limiting.

Although several specific embodiments and examples of the invention have been described and illustrated, the invention is not to be limited to specific forms or arrangements of parts so described and illustrated. The invention is limited only by the claims and the equivalents thereof.

1-20. (canceled)

21. A method, comprising:
by a printing device:
printing a document that includes a user designation area, wherein the user designation area includes a plurality of bubbles, each bubble associated with a particular answer choice for a particular question; then
after a user has completed at least one of the bubbles, determining which of the bubbles have been completed by the user; and
outputting, to a computer, data that indicates which of the bubbles have been completed by the user.

22. The method of claim 21, wherein at least one of the bubbles is oval shaped.

23. The method of claim 21, wherein the act of determining which of the bubbles have been completed by the user is performed using an optical mark reader coupled to a print cartridge.

24. The method of claim 23, further comprising:
if the determining step determines that at least one bubble was completed by the user, then placing the printed document in a first output tray of the printing device; and
if the determining step determines that no bubbles were completed by the user, then placing the printed document in an alternate output tray of the printing device.

25. The method of claim 21, wherein the computer receives and electronically stores a record of the data that indicates which of the bubbles have been completed by the user.

26. The method of claim 25, wherein the stored record is accessible by one or more client computers.

27. The method of claim 21, further comprising: receiving, by the printing device, additional data from the computer, wherein the additional data describes printable information that is generated based upon the data that indicates which of the bubbles have been completed by the user.

28. The method of claim 27, further comprising: printing, by the printing device, the printable information on to the printed document.

29. The method of claim 28,
wherein the printing is performed using a print cartridge; and
wherein the determining which of the bubbles have been completed by the user is performed using an optical mark reader coupled to the print cartridge.

30. The method of claim 29, wherein the print cartridge is an ink jet cartridge.

31. The method of claim 28, wherein the step of printing the printable information on the printed document further comprises printing information that indicates which of the particular answer choices is a correct answer choice and which of the particular answer choices is an incorrect answer choice.

32. The method of claim 31, wherein the step of printing information that indicates which answer choice is a correct answer choice and which answer choice is an incorrect answer choice includes printing at least one of an X mark, a check mark, and a circle mark.

33. The method of claim 31, wherein printing the information that indicates which of the particular answer choices is correct and which of the particular answer choices is incorrect further comprises printing a first color to indicate a correct answer choice and a second color to indicate an incorrect answer choice.

34. The method of claim 28, wherein printing the printable information on the printed document further comprises printing user feedback based on the answer choice for a particular question, whereby the answer choice is associated with the bubbles that have been completed by the user.

35. The method of claim 34, wherein printing the user feedback further comprises printing text.

36. The method of claim 34, wherein printing the user feedback further comprises printing at least one photograph.

37. At least one processor readable medium comprising processor executable instructions which, when executed, directs a printer to:
access first data which describes a document;
print a first version of the document that includes a user designation area, wherein the user designation area includes a plurality of bubbles each of the bubbles associated with a particular answer choice for a particular question;
determine which one of the bubbles have been completed by the user;
output second data to a computer that indicates which user designation areas have been completed by the user;
receive third data from the computer, where the third data describes printable information which is configured based upon the completed bubbles;
print a second version of the document which includes the printable information.

38. At least one processor readable medium comprising processor executable instructions which, when executed, directs a computer to:
access first data that describes a document;
configure the data into a first printable version of the document which includes a user designation area, wherein the user designation area includes a plurality of bubbles each associated with a particular answer choice for a particular question;
output the first printable version of the document to a printing device, wherein the printing device prints the first printable version of the document;
after a user has completed at least one of the bubbles in the user designation area, access second data from the printing device that indicates which of the bubbles in the user designation area have been completed;
output a third data to the printing device where the third data has been configured based upon information included in the second data.
